(19) United States
(12) Patent Application Publication
(10) Pub. No.: US 2025/0061376 A1
(43) Pub. Date: Feb. 20, 2025

(54) FEDERATED LEARNING SYSTEM, FEDERATED LEARNING METHOD, AND RECORDING MEDIUM STORING INSTRUCTIONS TO PERFORM FEDERATED LEARNING METHOD

(71) Applicant: Korea Advanced Institute of Science and Technology, Daejeon (KR)

(72) Inventors: Seyoung YUN, Daejeon (KR); Seongyoon KIM, Daejeon (KR); Minchan JEONG, Daejeon (KR); Jaehoon OH, Daejeon (KR); Gihun LEE, Daejeon (KR)

(21) Appl. No.: 18/489,087

(22) Filed: Oct. 18, 2023

(30) Foreign Application Priority Data
Aug. 16, 2023 (KR) 10-2023-0107066

(51) Int. Cl. G06N 20/00

(52) U.S. Cl. CPC G06N 20/00

(57) ABSTRACT

There is provided a federated learning system. The federated learning system comprises: a central server including a central learning model; and a plurality of client devices, each including a local learning model trained by performing federated learning with the central learning model, wherein the central server is configured to transmit status information of the central learning model to each client device, receive status information of the trained local learning model from each client device, and update the central learning model based on the status information of the trained local learning model, wherein each client device is configured to update the status information of the central learning model to the local learning model, train the local learning model by using individual training data, determine the status information of the trained local learning model, and transmit status information of the trained local learning model to the central server.

### TECHNICAL FIELD

The present disclosure relates to a federated learning system for mitigating data heterogeneity, a client device included in the federated learning system, and a federated learning method performed by the federated learning system and client device.

This work was supported by Institute of Information & communications Technology Planning & Evaluation (IITP) grant funded by Korea government (MSIT) (No. 2021-0-00907-003, Development of Adaptive and Lightweight Edge-Collaborative Analysis Technology for Enabling Proactively Immediate Response and Rapid Learning.

### BACKGROUND

Recent advancements in cloud and big data technologies have led to the widespread application of an artificial intelligence (AI) technology in various services. To apply the AI technology to the various services, it is necessary to precede training machine learning models based on large volumes of data.

The training of machine learning models requires substantial computational resources to conduct extensive calculations. For instance, cloud computing services offer cloud computing infrastructure for training machine learning models without installation of complex hardware and software. Since cloud computing is based on centralization of resources, all necessary data should be stored in cloud memory and utilized for training of machine learning models. While data centralization offers benefits maximizing efficiency, it poses risks to user data privacy and incurs significant network costs due to accompanying data transmission.

Recently, to overcome these problems, federated learning has been actively researched. Federated learning is a training method aggregating models directly trained by each client device based on individual data that the client devices possess rather than an existing training method centralizing user data for training. The federated learning may reduce privacy concerns because it does not centralize user data, and it can save on network costs because it transmits status information such as parameters of an updated model.

### SUMMARY

According to embodiments of the present disclosure, a technology that trains learning models of clients to be robust against data heterogeneity occurring during federated learning process is proposed.

According to embodiments of the present disclosure, a technology that a central server aggregates and trains learning models of clients to be robust against data heterogeneity occurring during federated learning process is proposed.

However, the problem to be solved by the present disclosure is not limited as mentioned above, and although not mentioned, it may include a purpose that can be clearly understood by those of ordinary skill in the art to which the present disclosure belongs from the description below. In accordance with an aspect of the present disclosure, there is provided a federated learning system, the federated learning system comprises: a central server including a central learning model; and a plurality of client devices, each including a local learning model trained by performing federated learning with the central learning model, wherein the central server is configured to transmit status information of the central learning model to each client device, receive status information of the trained local learning model from each client device, and update the central learning model based on the status information of the trained local learning model, wherein each client device is configured to update the status information of the central learning model to the local learning model, train the local learning model by using individual training data, determine the status information of the trained local learning model, and transmit status information of the trained local learning model to the central server, wherein the central server is configured to normalize a feature vector of training data that is input to the central learning model when updating the central learning model, and wherein each client device is configured to normalize a feature vector of training data that is input to the local learning model when training the local learning model.

Each client device may be configured to normalize the feature vector into a unit vector by setting a norm of the feature vector to one.

The central server may be configured to transmit status information of the central learning model to each client device, each client devices may be configured to update the status information of the central learning model to the local learning model, and then train the local learning model by using individual training data, and each client device may be configured to normalize a feature vector of training data that is input to the local learning model when training the local learning model.

Each client devices may be configured to normalize the feature vector into a unit vector by setting a norm of the feature vector to one.

The central server may be configured to normalize the feature vector into a unit vector by setting a norm of the feature vector to one.

The central server may be configured to select each client device randomly for each iteration of updates through sampling.

The central server may be configured to update the central learning model by aggregating and averaging the status information of the trained local learning model received from each client device.

In accordance with another aspect of the present disclosure, there is provided a non-transitory computer-readable recording medium storing a computer program, comprising commands for a processor to perform a federated learning method, the method comprises: preparing a local learning model configured to perform federated learning with a central server including a central learning model and other client device, updating status information of the central learning model to an extraction unit of the local learning model, training the local learning model by using individual training data, and transmitting the status information of the trained local learning model stored in the extraction unit of the trained local learning model to the central server to be updated in an extraction unit of the central learning model, wherein the training the local learning model includes normalizing a feature vector of training data input to the local learning model.

The feature vector may be normalized into a unit vector by setting a norm of the feature vector to one.

The training the local learning model may include updating the status information of the central learning model to the local learning model, and training the local learning model by using individual training data.

In accordance with another aspect of the present disclosure, there is provided a federated learning method performed by a central server and a plurality of client devices, the method comprises: transmitting, by the central server, status information of a central learning model to each client device; updating, by each client device, the status information of the central learning model to a local learning model; training, by each client device, the local learning model by using individual training data; transmitting, by each client device, status information of the trained local learning model to the central server; and updating, by the central server, the central learning model by using the status information of the trained local learning model received from each client device, wherein the training the local learning model includes normalizing a feature vector of training data that is input to the local learning model, and wherein the updating the central learning model includes normalizing a feature vector of training data that is input to the central learning model.

The normalizing the feature vector of the training data that is input to the local learning model may include normalizing the feature vector into a unit vector by setting a norm of the feature vector to one.

The normalizing the feature vector of the training data that is input to the central learning model may include normalizing the feature vector into a unit vector by setting a norm of the feature vector to one.

The federated learning method may include transmitting the status information of the updated central learning model to each client device; updating, by each client device, the status information of the updated central learning model to the trained local learning model; and training, by each client device, the trained local learning model by using individual training data.

The federated learning method may include selecting, by the central server, each client device randomly for each iteration of updates through sampling.

The federated learning method may include updating, by the central server, the central learning model by aggregating and averaging status information of the trained local learning model.

According to embodiments of the present disclosure, when generating learning models of clients that will be aggregated at the central server during the federated learning process, data heterogeneity occurring during federated learning process can be minimized by applying feature vector normalization forcibly setting a size of a feature vector extracted from arbitrary data to 1.

The effects achievable from the present disclosure are not limited to the effects described above, and other effects not mentioned above will be clearly understood by those skilled in the art, where the present disclosure belongs, from the following description.

### BRIEF DESCRIPTION OF THE DRAWINGS

FIG. 1 illustrates a configuration of a federated learning system according to an embodiment of the present disclosure.

FIG. 2 illustrates an example of a structure of a federated learning model used in a federated learning system according to an embodiment of the present disclosure.

FIG. 3 illustrates an example of a process in which a central server transmits status information to each client device, and each client device trains individual training data according to an embodiment of the present disclosure.

FIG. 4 illustrates an example of a process in which each client device transmits updated status information to a central server, and the central server aggregates the updated status information of each client device to update a federated learning model according to an embodiment of the present disclosure.

FIG. 5 illustrates an example of a process in which a central server transmits aggregated and updated status information to each client device and each client device trains individual training data based on the updated status information according to an embodiment of the present disclosure.

FIG. 6 is a flowchart illustrating a signal processing process where a central server and each client device perform a federated learning method according to an embodiment of the present disclosure.

FIG. 7 illustrates an example of an evaluation process for results of federated learning by a central server and client devices according to an embodiment of the present disclosure.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

The primary issue in federated learning is data heterogeneity among clients. Because clients generate data in various locations and environments, data distribution and characteristics may be different from each other, and this data heterogeneity may contribute to the degradation of federated learning performance.

In an embodiment of the present disclosure, a method training a learning model of a client to be robust against data heterogeneity that may occur during the federated learning process is proposed and a policy in which a central server aggregates learning models of clients to be robust against data heterogeneity is proposed.

Hereinafter, referring to attached drawings, an embodiment of the present disclosure will be described in detail for those skilled in the art where the disclosure is included to easily implement the embodiment. In addition, to clearly describe the present disclosure, unrelated description will be omitted.

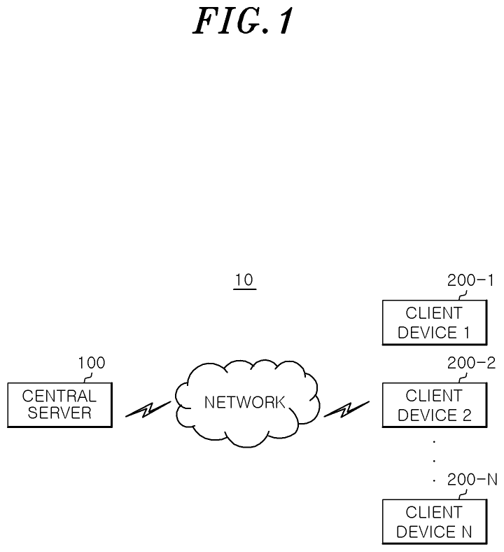

FIG. 1 illustrates a configuration of a federated learning system 10 according to an embodiment of the present disclosure.

Referring to FIG. 1, the federated learning system 10 according to an embodiment of the present disclosure may include a central server 100 and a plurality of client devices 200.

The central server 100 and client devices 200 may be computing devices including memory and processors, thereby performing overall operations through commands stored in memory and processor operations.

The central server 100 and client devices 200 may store artificial intelligence neural network models designed with the same structure for performing the federated learning.

Hereinafter, in describing the federated learning according to an embodiment of the present disclosure, a federated learning model stored in the central server 100 is referred to as a “central learning model,” and federated learning models stored in the plurality of client devices 200 are referred to as “local learning models.”

General operations that the central server 100 and client devices 200 included in the federated learning system 10 train the federated learning model are as follows.

First, the central server 100 may transmit status information, such as a parameter value set in the central learning model, to each client device 200.

Thereafter, each client device 200 may train local learning models by using individual training data and transmit status information of the trained local learning models, such as parameter values, to the central server 100.

Subsequently, the central server 100 may aggregate the status information of the local learning models trained by each client device 200 and update the status information of the central learning model.

In this way, a series of steps where the central server 100 transmits the status information to client devices 200, aggregates newly trained status information, and then updates the central learning model may be understood as one round of the federated learning. The federated learning process may include a plurality of rounds based on the setting, and finally updated status information of the central learning model and each local learning model may be obtained after the final round.

At this time, the central server 100 may randomly select, for each round of the federated learning, at least one client device from among the plurality of client devices 200 based on a certain principle (e.g., FedAvg, FedSGD, FedMA, etc.) to transmit the status information.

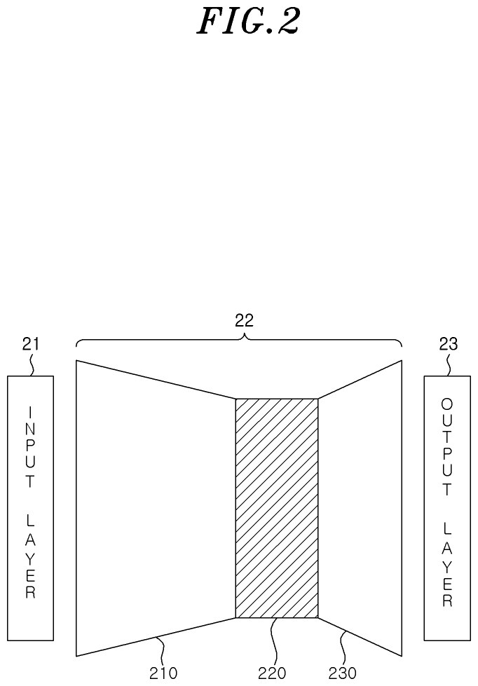

At this time, the central server 100 may update the status information of the central learning model by reflecting an average value of the status information aggregated from at least one client device 200 based on a certain principle (e.g., FedAvg, FedSGD, FedMA, etc.) FIG. 2 illustrates an example of a structure of a federated learning model and local learning models used in a federated learning system 10 according to an embodiment of the present disclosure.

Referring to FIG. 2, the central learning model and the local learning models according to an embodiment of the present disclosure may include a neural network including an input layers 21, hidden layers 22, and output layers 23. For example, the hidden layers 22 of the central learning model and local learning models in the federated learning system 10 according to an embodiment of the present disclosure may include an extraction unit 210, a normalization unit 220, and a classification unit 230.

The extraction unit 210 may include layers, among layers included in the federated learning model, from a layer at the very front which directly faces the input layer to a layer just before the last layer of the hidden layers 22. For example, the extraction unit 210 may include a network layer including a parameter that extracts a feature vector from training data, such as a specific image, that is input to the central learning model and local learning models, and performs convolution operations by applying weights and biases to the extracted feature vector.

The normalization unit 220 may normalize the feature vectors extracted by the extraction unit 210 in case of training the central learning model and the local learning models according to an embodiment of the present disclosure.

At this time, normalization, for example, may set a size (norm or length) of the extracted feature vector to 1, resulting in the feature vector being normalized into a unit vector. Such normalization, in an embodiment of the present disclosure, may enhance the stability of learning from data heterogeneity during training the central learning model and local learning models.

The classification unit 230 may include the last layer facing the output layer within layers included in the federated learning model. For example, the classification unit 230 may include a network layer including a parameter that identifies decision boundary for classifying the output layers.

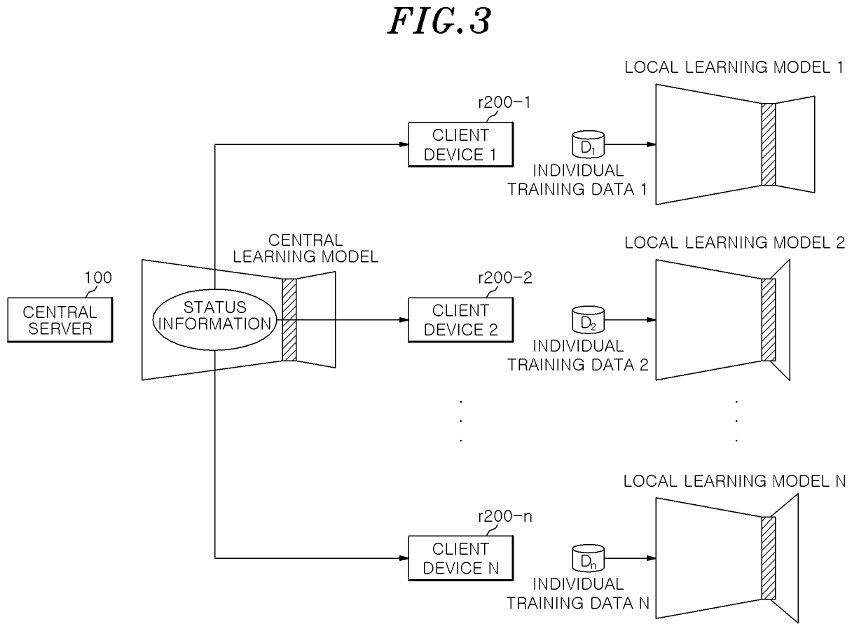

FIG. 3 illustrates an example of a process in which the central server 100 transmits status information of an extraction unit in the central learning model to each client device 200, and each client device 200 uploads the received status information to an extraction unit in the local learning model to train according to an embodiment of the present disclosure.

The central server 100 may transmit the status information of the extraction unit in the central learning model to a plurality of client devices 200. At this time, the central server 100 may, for each round of the federated learning, select some client devices from among all client devices 200 to transmit the status information according to a predetermined method (e.g., FedAvg, FedSGD, FedMA, etc.) For example, the central server 100 may randomly select at least one client device from among the plurality of client devices 200 for each iteration of updates through a sampling method. In the following description, at least one randomly selected client device is referred to as a “selected client device,” and for convenience in the description, a reference number is denoted as r200.

As illustrated in FIG. 3, the selected client devices r200-1, r200-2, . . . , and r200-n upload the status information received from the central server 100 to respective local learning models stored therein. Then, each selected client devices r200-1, r200-2, . . . , and r200-n may use its individual data D1, D2, . . . , and Dn to train an extraction unit and classification unit in the local learning model through a pre-determined learning algorithm (e.g., FedReNTD, etc.) Herein, when training the extraction unit and classification unit in the local learning model, the selected client devices r200-1, r200-2, . . . , and r200-n may normalize training data, such as feature vectors of training images, that are input into the local learning model.

On the other hand, when performing the training of the local learning model, the selected client devices r200-1, r200-2, . . . , and r200-n may configure individual training data D1, D2, . . . , and Dn stored respectively in the selected client devices r200-1, r200-2, . . . , and r200-n into images and labels, input the images among the images and labels into a supervised learning model and the local learning models, and set a goal to make accurate predictions for the given labels for the input images.

Among the images and labels included in the individual training data D1, D2, . . . , and Dn, the labels are answer probability vectors. Therefore, the selected client devices r200-1, r200-2, . . . , and r200-n may use a probability vector generator transforming output vectors of the supervised learning model and local learning models into probability vectors to compare with the answer probability vectors. Results of probability vectors may vary depending on how a hyperparameter τ is generated in the probability vector generator.

Furthermore, the selected client devices r200-1, r200-2, . . . , and r200-n may train in a direction that reduces an objective loss function, which is calculated from the probability vector generated from the answer probability vectors that are labels among the images and labels included in the individual training data D1, D2, . . . , and Dn, and the output vectors generated from the supervised learning model and the local learning models. Herein, the objective loss function may reflect not only an NTD loss function but also a cross-entropy loss function.

Thereafter, the selected client devices r200-1, r200-2, . . . , and r200-n may calculate the objective loss function as the sum of the NTD loss function and the cross-entropy loss function.

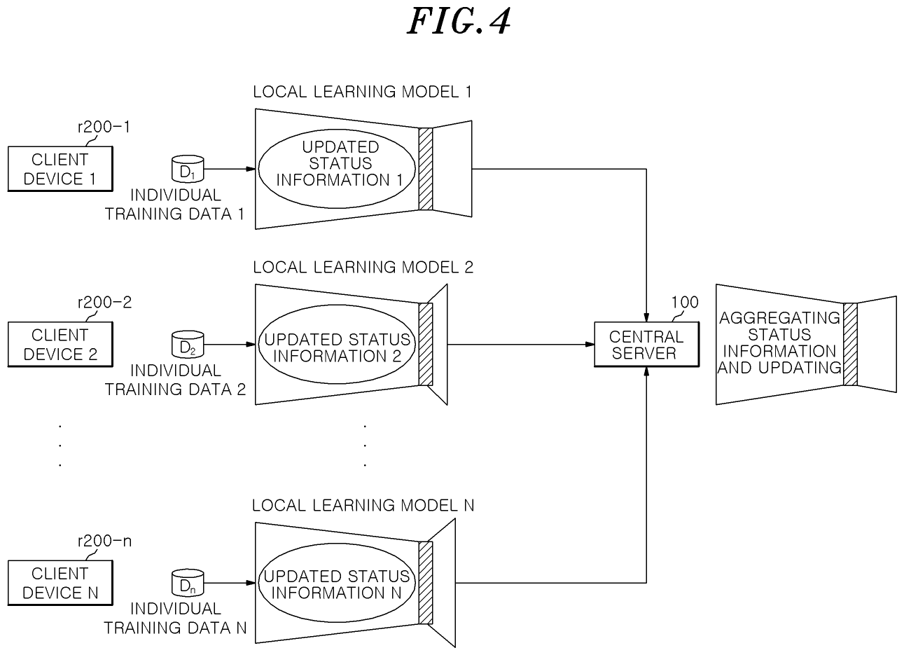

FIG. 4 illustrates an example of a process in which selected client devices r200-1, r200-2, . . . , and r200-n transmits updated status information of local learning models to the central server 100, and the central server 100 aggregates the updated status information of the selected client devices r200-1, r200-2, . . . , and r200-n to update status information of a central learning model according to an embodiment of the present disclosure.

Referring to FIG. 4, the selected client devices r200-1, r200-2, . . . , and r200-n may transmit, to the central server 100, the updated status information of the local learning models trained by using respective individual training data D1, D2, . . . , and Dn stored therein. In this case, the central server 100 may, according to a predetermined method (e.g., FedAvg, FedSGD, FedMA, etc., combine the aggregated status information of the client devices 200, for example, by taking an average, and update the status information in the central learning model.

According to an embodiment of the present disclosure, a process described in FIGS. 3 and 4 may be understood as one round of the federated learning in which the central server 100 and the client devices 200 participate together. The federated learning round in FIGS. 3 and 4 may proceed a predefined number of iterations based on the designer's selection.

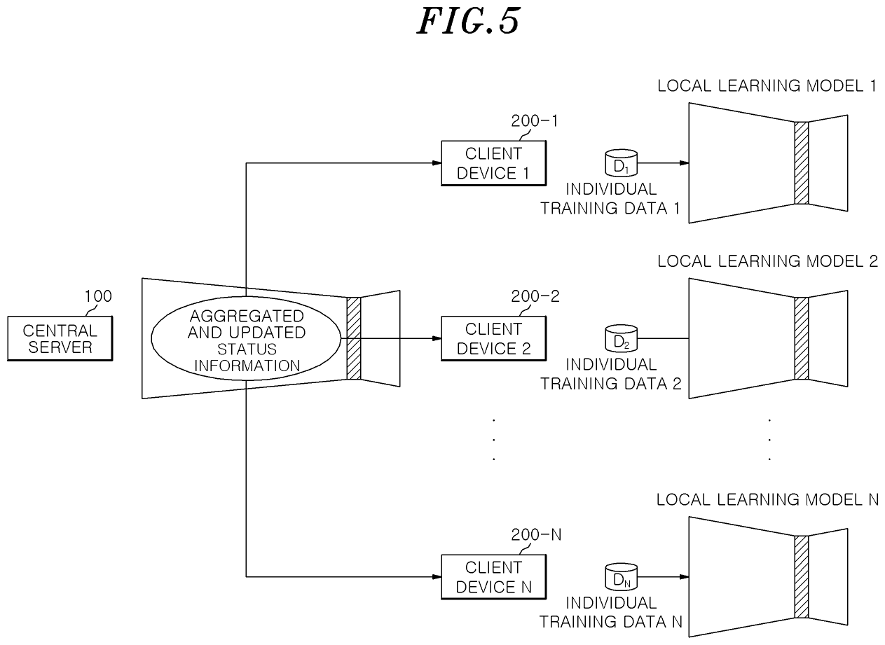

FIG. 5 illustrates an example of a process in which the central server 100 transmits aggregated and updated status information to all of a plurality of the client devices 200-1, 200-2, and 200-N, and the plurality of the client devices 200-1, 200-2, . . . , and 200-N train individual training data based on the updated status information according to an embodiment of the present disclosure.

As illustrated in FIG. 5, the central server 100 may transmit the updated status information of the central learning model to the plurality of the client devices 200-1, 200-2, . . . , and 200-N.

The plurality of the client devices 200-1, 200-2, . . . , and 200-N may upload the status information of the central learning that was updated by the central server 100 to their local learning models, and then train the local learning models by using individual learning data.

Herein, when training the local learning model, the plurality of the client devices 200-1, 200-2, . . . , and 200-N may normalize training data, such as feature vectors of training images, that is input into the local learning model.

The plurality of the client devices 200-1, 200-2, . . . , and 200-N may normalize the feature vector into a unit vector by setting the size of the feature vector to 1. Through the normalization, plurality of the client devices 200-1, 200-2, . . . , and 200-N may enhance the stability of learning from data heterogeneity in the embodiment of the present disclosure.

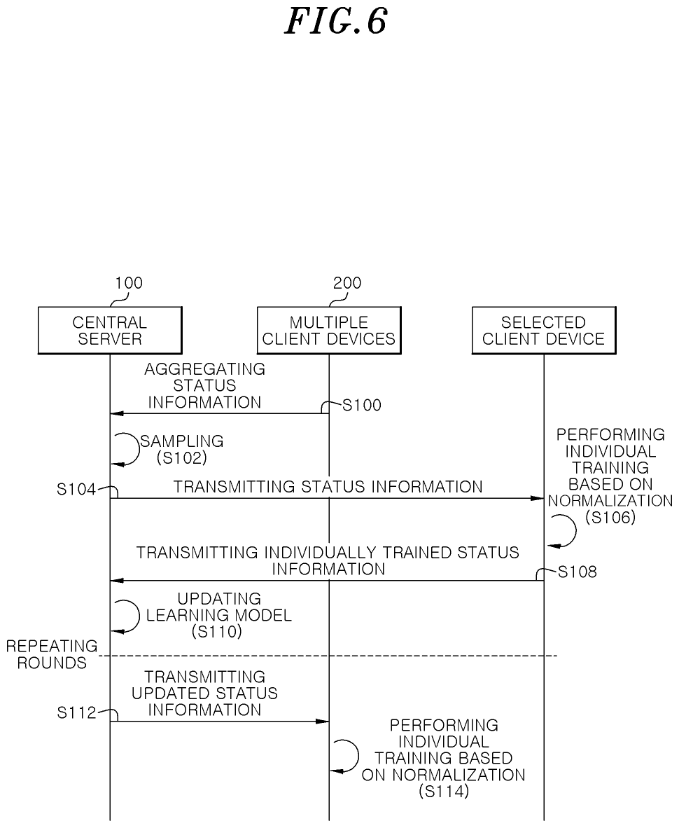

FIG. 6 is a flowchart illustrating a signal processing process where the central server 100 and client devices 200 and a selected client device r200 perform a federated learning method according to an embodiment of the present disclosure.

As shown in FIG. 6, in a step S100, the central server 100 may receive, from a plurality of client devices 200, and aggregate status information of local learning models.

Thereafter, in a step S102, the central server 100 may perform sampling of the status information of local learning models that is received from the plurality of the client devices 200 and aggregated. Herein, the sampling may be a process of selecting at least one client device to increase learning efficiency under the situation where the number of the plurality of client devices 200 is significantly large, and at least one client device may be randomly selected from among the plurality of the client devices 200 in each iteration of updates of the central server 100 that will be described below.

Once at least one client device is selected, in a S104, the central server 100 may transmit the status information of the central learning model to the selected client device r200.

Upon receiving, at the selected client device r200, the status information of the central learning model, in a step S106, the selected client device r200 may upload the received status information of the central learning model to its local learning model, and then train the local learning model by using individual training data. Herein, the selected client device r200 may train its local learning model by performing individual training based on normalization according to an embodiment of the present disclosure. The normalization may be a process of setting a size of feature vectors of training data to 1, which normalizes the feature vectors to unit vectors.

Thereafter, in a step S108, the selected client device r200 may transmit the individually trained status information to the central server 100.

In a step S110, the central server 100 may update its central learning model based on the individually trained status information received from the selected client device r200. Herein, the central server 100 may normalize the feature vectors of training data input into the central learning model during the update of the central learning model, where normalization may be a process of setting the size of feature vectors to 1, which normalizes the feature vectors to unit vectors. Furthermore, when updating the status information received from the selected client device r200, the central server 100 may aggregate and average the status information of the local learning model of the selected client device r200.

Thereafter, the central server 100 may check the number of rounds repeated from the step S100 to the step S110, and proceed to a step S112 once a predetermined number of rounds is reached.

In the step S112, the central server 100 may transmit the finally updated status information of the central learning model to all of the plurality of the client devices 200.

Once receiving the updated status information of the central learning model, in a step S114, the plurality of the client devices 200 may upload the updated status information of the central learning model to the respective local learning models stored therein, and then train the local learning models by using individual training data. Herein, according to an embodiment of the present disclosure, the plurality of the client devices 200 may train their local learning models by performing individual training based on normalization. The normalization may be a process of setting the size of the feature vectors of training data to 1, which normalizes the feature vectors to unit vectors.

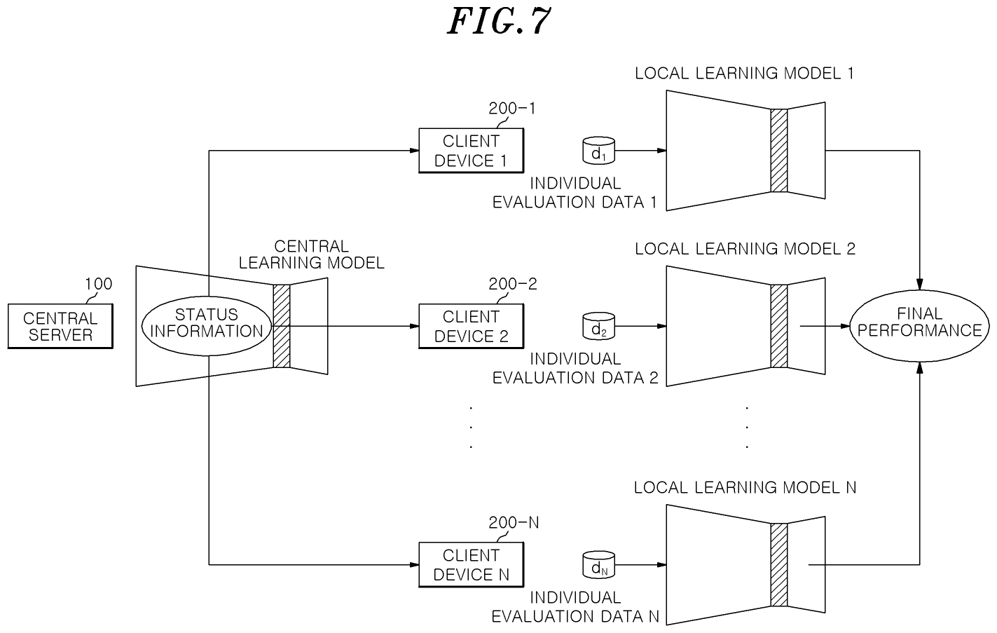

FIG. 7 illustrates an example of an evaluation process for results of federated learning by the central server 100 and a plurality of client devices 200-1, 200-2, . . . , and 200-N according to an embodiment of the present disclosure.

The central server 100 may transmit status information of an extraction unit in a central learning model to all the client devices 200-1, 200-2, . . . , and 200-N participating in federated learning, each client device 200-1, 200-2, . . . , and 200-N may upload the status information received from the central server 100 to respective local learning models stored therein. In addition, each client device 200-1, 200-2, . . . , and 200-N may input individual evaluation data d1, d2, . . . , and dN into the local learning model, and then combine prediction success rates by each client device 200-1, 200-2, . . . , and 200-N, for example, by taking an average, thereby evaluating as a final performance of the federated learning by the central server 100 and the client devices 200-1, 200-2, . . . , and 200-N.

In an embodiment of the present disclosure, a method (full update) that does not constrain the learning model itself is applied, and is compared to a case updating an extraction unit in a learning model as shown in the [Experimental Example] below. In an environment of the [Experimental Example], dataset is Cifar100, the learning model is MobileNet (identical to the FedBABU thesis), a client's sampling ratio (f) for each round of the federated learning is 0.1, and the number of local epochs to create a client learning model is unified at 5.

### EXPERIMENTAL EXAMPLE

This experimental example considers both global federated learning (GFL) and personalized federated learning (PFL) as shown in the [Table 1] and [Table 2].

TABLE 1

| f = 0.1 | Body | Full | FN |
|---|---|---|---|
| shard 100 | 40.49 | 43.19 | 51.51 |
| shard 50 | 40.76 | 40.63 | 50.6 |
| shard 10 | 45.56 | 36.6 | 46.87 |

TABLE 2

| | Body | | Full | | FN | |
|---|---|---|---|---|---|---|
| f = 0.1 | Initial | Personalized | Initial | Personalized | Initial | Personalized |
| shard 100 | 40.49_{±4.21} | 46.26_{±5.04} | 43.19_{±5.31} | 47.26_{±4.67} | 51.51_{±4.91} | 56.32_{±4.62} |
| shard 50 | 40.76_{±4.78} | 53.05_{±5.0} | 40.63_{±5.0} | 49.57_{±5.37} | 50.6_{±5.13} | 61.45_{±5.69} |
| shard 10 | 45.76_{±7.21} | 78.66_{±6.15} | 36.6_{±7.75} | 77.64_{±6.64} | 46.87_{±7.28} | 82.06_{±6.18} |

In the [Table 1] and [Table 2], a federated learning method through individual full training with normalization according to an embodiment of the present disclosure is referred to as FN, a case where the extraction unit is updated is referred to as Body, and full training without the normalization is referred to as Full.

The [Table 1] shows results of global federated learning, and the [Table 2] shows results of personalized federated learning. As shown in the [Table 1] and [Table 2], it can be observed that the FN according to an embodiment of the present disclosure obtains improved results compared to Body or Full in all cases.

On the other hand, a computer program may be implemented to include instructions that cause a processor to perform each step included in the federated learning method by client devices and the federated learning method by a central server and a plurality of client devices, according to the above-described embodiment.

Furthermore, a computer program including instructions that cause a processor to perform each step included in the federated learning method by client devices and the federated learning method by a central server and a plurality of client devices, according to the above-described embodiment, may be stored in a computer-readable storage medium.

As described heretofore, according to an embodiment of the present disclosure, through the federated learning where the central server transmits status information of the extraction unit in the central learning model to the client device, the client device uploads the received status information to the extraction unit in the individual learning model, and then performs training of the extraction unit and the classification unit by using the individual training data, and transmits updated status information through the training to the central server, the representation is improved, ultimately enhancing the performance of federated learning.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A federated learning system comprising:
a central server including a central learning model; and
a plurality of client devices, each including a local learning model trained by performing federated learning with the central learning model,
wherein the central server is configured to transmit status information of the central learning model to each client device, receive status information of the trained local learning model from each client device, and update the central learning model based on the status information of the trained local learning model,
wherein each client device is configured to update the status information of the central learning model to the local learning model, train the local learning model by using individual training data, determine the status information of the trained local learning model, and transmit status information of the trained local learning model to the central server,
wherein the central server is configured to normalize a feature vector of training data that is input to the central learning model when updating the central learning model, and
wherein each client device is configured to normalize a feature vector of training data that is input to the local learning model when training the local learning model.

2. The federated learning system of claim 1, wherein each client device is configured to normalize the feature vector into a unit vector by setting a norm of the feature vector to one.

3. The federated learning system of claim 1,
wherein the central server is configured to transmit status information of the central learning model to the plurality of client devices,
wherein the plurality of client devices are configured to update the status information of the central learning model to the local learning model, and then train the local learning model by using individual training data, and
wherein the plurality of client devices are configured to normalize a feature vector of training data that is input to the local learning model when training the local learning model.

4. The federated learning system of claim 3, wherein the plurality of client devices are configured to normalize the feature vector into a unit vector by setting a norm of the feature vector to one.

5. The federated learning system of claim 1, wherein the central server is configured to normalize the feature vector into a unit vector by setting a norm of the feature vector to one.

6. The federated learning system of claim 1, wherein the central server is configured to select each client device randomly for each iteration of updates through sampling.

7. The federated learning system of claim 1, wherein the central server is configured to update the central learning model by aggregating and averaging the status information of the trained local learning model received from each client device.

8. A non-transitory computer-readable recording medium storing a computer program, comprising commands for a processor to perform a federated learning method, the method comprising:
preparing a local learning model configured to perform federated learning with a central server including a central learning model and other client device,
updating status information of the central learning model to an extraction unit of the local learning model,
training the local learning model by using individual training data, and
transmitting the status information of the trained local learning model stored in the extraction unit of the trained local learning model to the central server to be updated in an extraction unit of the central learning model,
wherein the training the local learning model includes normalizing a feature vector of training data input to the local learning model.

9. The non-transitory computer-readable recording medium of claim 8, wherein the feature vector is normalized into a unit vector by setting a norm of the feature vector to one.

10. The non-transitory computer-readable recording medium of claim 8, wherein the training the local learning model includes updating the status information of the central learning model to the local learning model, and training the local learning model by using individual training data.

11. A federated learning method performed by a central server and a plurality of client devices, comprising:
transmitting, by the central server, status information of a central learning model to each client device;
updating, by each client device, the status information of the central learning model to a local learning model;
training, by each client device, the local learning model by using individual training data;
transmitting, by each client device, status information of the trained local learning model to the central server; and
updating, by the central server, the central learning model by using the status information of the trained local learning model received from each client device,
wherein the training the local learning model includes normalizing a feature vector of training data that is input to the local learning model, and
wherein the updating the central learning model includes normalizing a feature vector of training data that is input to the central learning model.

12. The federated learning method of claim 11, wherein the normalizing the feature vector of the training data that is input to the local learning model includes normalizing the feature vector into a unit vector by setting a norm of the feature vector to one.

13. The federated learning method of claim 11, wherein the normalizing the feature vector of the training data that is input to the central learning model includes normalizing the feature vector into a unit vector by setting a norm of the feature vector to one.

14. The federated learning method of claim 11, further comprising:
transmitting the status information of the updated central learning model to each client device;
updating, by each client device, the status information of the updated central learning model to the trained local learning model; and
training, by each client device, the trained local learning model by using individual training data.

15. The federated learning method of claim 11, further comprising:
selecting, by the central server, each client device randomly for each iteration of updates through sampling.

16. The federated learning method of claim 11, further comprising:
updating, by the central server, the central learning model by aggregating and averaging status information of the trained local learning model.
